(19) United States
(12) Patent Application Publication
(10) Pub. No.: US 2022/0241682 A1
(43) Pub. Date: Aug. 4, 2022

(54) Analog Joystick-Trackpad

(71) Applicant: Reed Ridyolph, Cuero, TX (US)

(72) Inventor: Reed Ridyolph, Cuero, TX (US)

(21) Appl. No.: 17/163,503

(22) Filed: Jan. 31, 2021

(51) Int. Cl. A63F 13/24; G06F 3/038; G06F 3/0354; G06F 3/0338

(52) U.S. Cl. CPC A63F 13/24; G06F 3/0338; G06F 3/03547; G06F 3/038

(57) ABSTRACT

The joystick input controller includes a concave and circular touch sensitive surface, a coordinate transformer for converting the 2-dimensional coordinate into a joystick coordinate, the coordinate transformer comprises a look-up table having and address input and a stored data value, and a digital device interface for communicating input position data containing the joystick coordinate to the computing device, The digital device interface corresponds to a digital data communications interface. The joystick coordinates corresponds to a circle limited coordinates. The touch sensitive surface generates a 2-dimensional coordinate correspond to a point of contact by a user at on the touch sensitive surface, the touch sensitive surface generates an x-axis value and a y-axis value, and a center location of the touch sensitive surface having a lowest point in the concave surface generates the x-axis value equal 512 and the y-axis value equal to 512. The address input to the look-up table corresponds to the x-axis value and the y-axis value concatenated together, and the stored data value at each location within the loop-up table corresponds to a 2-dimensional position within the joystick coordinates.

### TECHNICAL FIELD

This application relates in general to an article of manufacture for providing a computer user interface device, and more specifically, to an article of manufacture providing an analog joystick utilizing a trackpad.

### BACKGROUND

The analog dep is a track pad shaped like a bowl or crater (a DEPression), which will emulate analog input like the standard joysticks it is meant to replace. The idea is to substantially improve durability, as a track pad is virtually impervious to fatigue and is inside of the controller rather than outside like the stick. Analog controllers are often rendered useless due to analog sticks being prone to damage in relatively rapid succession. The dep, however, resolves the fatigue issue while still being operated in a familiar way. The dep also may be more accurate than the traditional stick.

Therefore, a need exists for an article of manufacture for providing an analog joystick utilizing a trackpad. The present invention attempts to address the limitations and deficiencies in prior solutions according to the principles and example embodiments disclosed herein.

### SUMMARY

In accordance with the present invention, the above and other problems are solved by providing an article of manufacture for an analog joystick utilizing a trackpad according to the principles and example embodiments disclosed herein.

In one embodiment, the present invention is an article of manufacture for providing an analog joystick utilizing a trackpad. The joystick input controller includes a concave and circular touch sensitive surface, a coordinate transformer for converting the 2-dimensional coordinate into a joystick coordinate, the coordinate transformer comprises a look-up table having and address input and a stored data value, and a digital device interface for communicating input position data containing the joystick coordinate to the computing device, The digital device interface corresponds to a digital data communications interface. The joystick coordinates corresponds to a circle limited coordinates. The touch sensitive surface generates a 2-dimensional coordinate correspond to a point of contact by a user at on the touch sensitive surface, the touch sensitive surface generates an x-axis value and a y-axis value, and a center location of the touch sensitive surface having a lowest point in the concave surface generates the x-axis value equal 512 and the y-axis value equal to 512. The address input to the look-up table corresponds to the x-axis value and the y-axis value concatenated together, and the stored data value at each location within the loop-up table corresponds to a 2-dimensional position within the joystick coordinates.

The foregoing has outlined rather broadly the features and technical advantages of the present invention in order that the detailed description of the invention that follows may be better understood. Additional features and advantages of the invention will be described hereinafter that form the subject of the claims of the invention.

It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only, and is not intended as a definition of the limits of the present invention.

### BRIEF DESCRIPTION OF THE DRAWINGS

Referring now to the drawings in which like reference numbers represent corresponding parts throughout:

FIGS. 1a-b illustrates an example embodiment of an article of manufacture providing an analog joystick utilizing a trackpad according to the present invention.

FIG. 2 illustrates a joystick coordinate system for use within an article of manufacture providing an analog joystick utilizing a trackpad according to the present invention.

FIG. 3 illustrates a logical block diagram of components within an article of manufacture for providing an analog joystick utilizing a trackpad according to the present invention.

### DETAILED DESCRIPTION

This application relates in general to an article of manufacture for a computer user interface device, and more specifically, to an article of manufacture for providing an analog joystick utilizing a trackpad according to the present invention.

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In describing embodiments of the present invention, the following terminology will be used. The singular forms “a,” “an,” and “the” include plural referents unless the context clearly dictates otherwise. Thus, for example, reference to “a needle” includes reference to one or more of such needles and “etching” includes one or more of such steps. As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. As used herein, the singular forms “a,” “an,” and “the” are intended to include the plural forms as well, unless the context clearly indicates otherwise.

It further will be understood that the terms “comprises,” “comprising,” “includes,” and “including” specify the presence of stated features, steps or components, but do not preclude the presence or addition of one or more other features, steps or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

The terms “player” and “user” refer to an entity, e.g. a human, using a trackpad as a joystick input device associated with the invention. The term user herein refers to one or more users.

The term “invention” or “present invention” refers to the invention being applied for via the patent application with the title “Analog Joystick by Trackpad.” Invention may be used interchangeably with dep or joystick by trackpad.

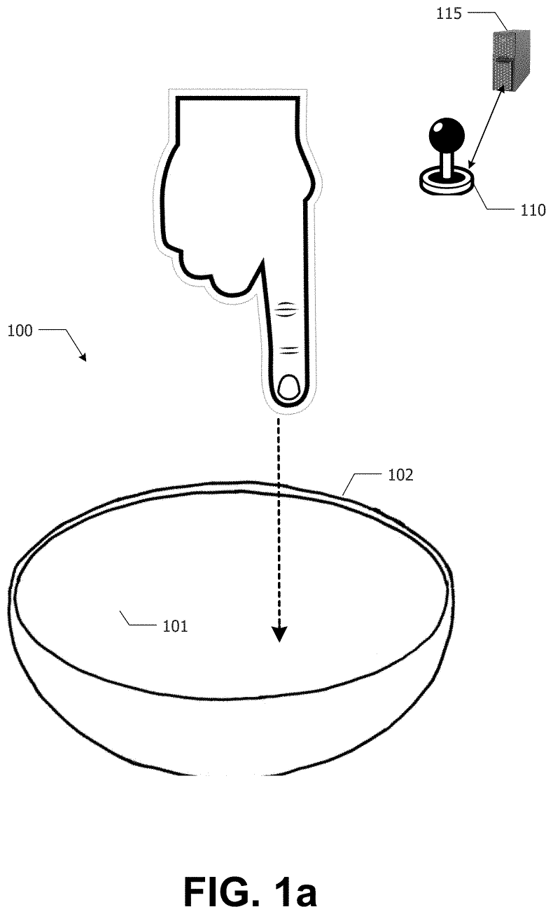

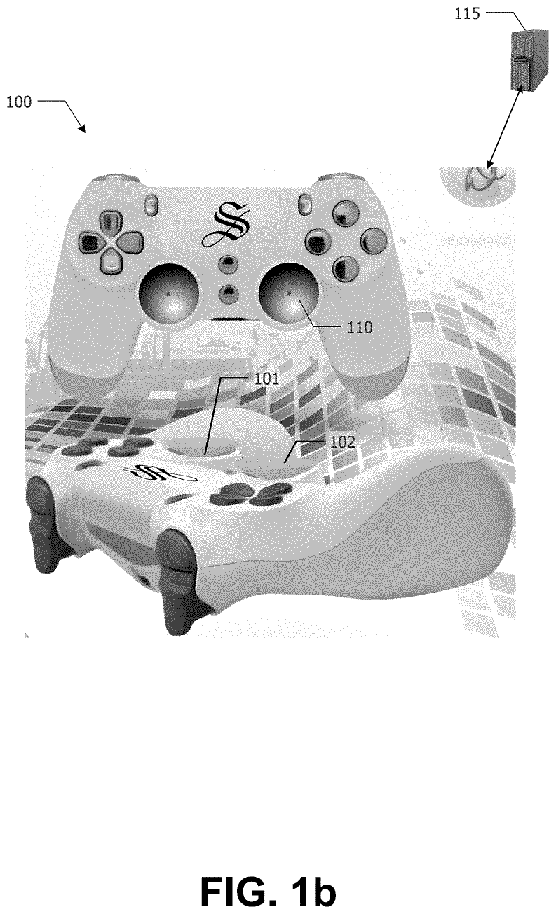

In general, the present disclosure relates to an article of manufacture for providing a computer user interface device. To better understand the present invention, FIG. 1a illustrates an example embodiment of an article of manufacture providing an analog joystick utilizing a trackpad according to the present invention. A joystick by trackpad 100, which is a user interface input device, is shown in FIG. 1b comprising a concave-shaped bowl structure 101 having a trackpad device 102 lining an inner surface of the bowl structure 101. The joystick by trackpad 100 outputs a position signal for a computing device, including gaming devices, gaming consoles, and computing systems that are used as user input mechanisms while playing various video games and similar applications.

An analog joystick 110, that also may be called a thumb stick, in one embodiment generates an analog voltage signal for each axis in a 2 dimensional (2D) coordinate system. An analog joystick 110 is coupled to a 2D gimbal device that permits the analog joystick 110 to move about a spatial area defined by the rotation of the 2D gimbals through an allowable arc. The gimbal device is typically coupled to an electronic wiper connection to a potentiometer that varies depending upon the position of each of the pair of gimbals. The value of a voltage measured across each of the potentiometers varies according to the position of the analog joystick 110 within each gimbal's arc of travel. By measuring these voltages, a 2D coordinate within a space may be calculated using these two gimbal coordinate values.

These gimbal coordinate values have been provided as input to the gaming devices either as a pair of analog signals corresponding to the voltages measured across the potentiometers or as a pair of digital values after this voltage is converted to a digital value using an analog-to-digital converter circuit that is known in the arts. Various gaming systems may use either of these to input signal forms depending upon its internal circuitry and a matching analog joystick 110 used.

A trackpad is typically touch sensitive surface that corresponds to a flat 2D input device that detects one or more positions located on the surface of the trackpad in which a user has contacted and/or depressed a finger. The trackpad generates a 2D coordinate for the location of the user contact to the trackpad surface that may be used by applications and games within programmable computing devices. For example, The touch sensitive surface generates a 2-dimensional coordinate correspond to a point of contact by a user at on the touch sensitive surface, the touch sensitive surface generates an x-axis value and a y-axis value, and a center location of the touch sensitive surface having a lowest point in the concave surface generates the x-axis value equal 512 and the y-axis value equal to 512. The flat surface of the trackpad provides a mechanism to provide input coordinates to the applications and games; however the user input is different than the input known by users of analog joysticks 100.

The joystick by trackpad 100 according to the present invention places a trackpad 102 along an inside surface of the concave-shaped bowl structure 101 that permits a user to provide coordinate input values into computing devices in a coordinate system mimicking an analog joystick 110 while using an electronic device having no moving components. As such, a more reliable and longer-lasting device is provided while providing a user input device that operates in a manner similar to existing analog joysticks 110.

A joystick by trackpad 100 acts as a joystick input controller includes a concave and circular touch sensitive surface, a coordinate transformer for converting the 2-dimensional coordinate into a joystick coordinate. In preferred embodiment, the joystick coordinates corresponds to a circle limited coordinates.

The coordinate transformer comprises a look-up table having and address input and a stored data value, and a digital device interface for communicating input position data containing the joystick coordinate to the computing device. The address input to the look-up table corresponds to the x-axis value and the y-axis value concatenated together, and the stored data value at each location within the loop-up table corresponds to a 2-dimensional position within the joystick coordinates.

In this regard, the concave shape of the trackpad 102 provides a natural surface to allow a user's thumb to easily return to the center of a trackpad 102 as release of a joystick 110 typically returns to a center position when released. Such a device provides an improvement to these types of user input devices as compared to existing input devices. Despite the fact that such a device is desired by users of analog joysticks 110, no such device has been previously created based upon the knowledge of one of ordinary skill in the arts.

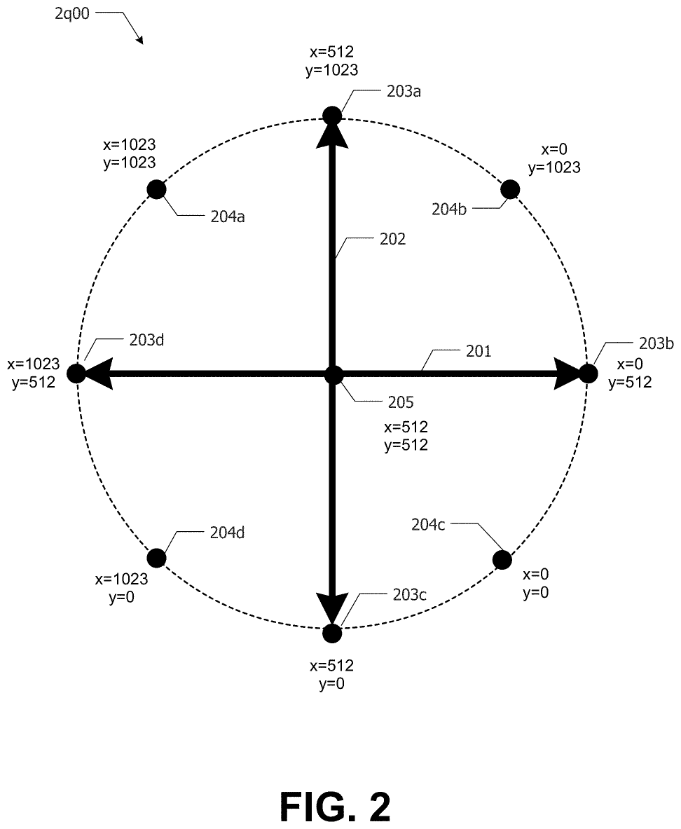

FIG. 2 illustrates a joystick coordinate system for use within an article of manufacture providing an analog joystick utilizing a trackpad according to the present invention. The joystick coordinate system 200 represents a position of a top point of a joystick as it moves throughout its 2D arcs of travel. The position of the top point of the joystick is then projected onto a 2D plane in which the coordinate positions are defined.

The 2D coordinate system 200 has an x-axis 201 and a perpendicular y-axis 202. The x-axis 201 begins with a value of 0 at a rightmost point 203b and ends with a maximum value at a leftmost point 203d. In the example embodiment of FIG. 2, the maximum value is 1023 and the coordinates range from 0 to 1023 which can be represented in a 6-bit digital number. Similarly, the y-axis 202 begins with a value of 0 at a bottommost point 203c and ends with a maximum value at a topmost point 203a. Once again in the example embodiment of FIG. 2, the maximum value is 1023 and the coordinates range from 0 to 1023 which can be represented in a 6-bit digital number. The center point 205 of the coordinate system 200 of FIG. 2 corresponds to x=512, y=512.

Using this coordinate system 200, additional positions defined by an angular position about an outer circle of the arcs of travel for the joystick 110 starting at 0° 203a are shown as follows: 45°-x=0, y=1023 204a, 135°-x=0, y=0 204b, 215°-x=1023, y=0 204c, and 315° -x=1023, y=1023 204d. All of the points within the circle defining the 2D arcs of travel are values between 0 and 1023. These coordinate positions in the joystick coordinate system 200 are the output of the joystick by trackpad 100 according to the present invention.

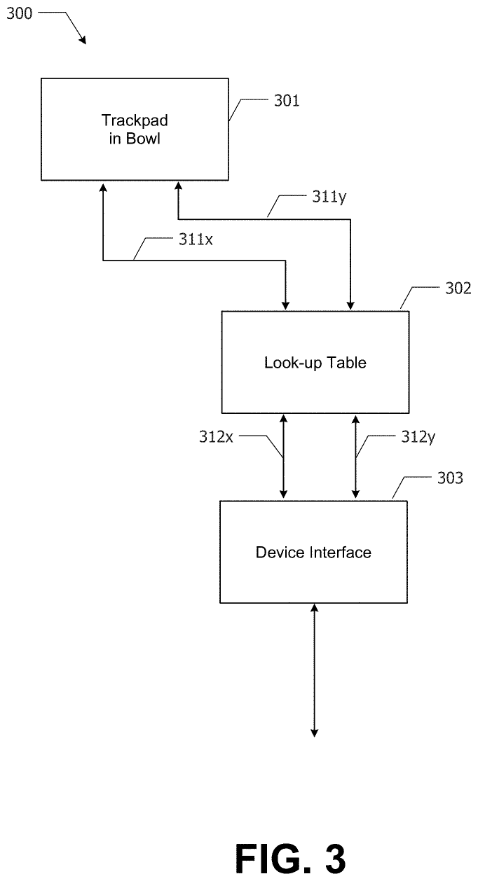

FIG. 3 illustrates a logical block diagram of components within an article of manufacture for providing an analog joystick utilizing a trackpad according to the present invention. Circuitry 300 within the joystick by trackpad 100 is shown comprising a trackpad 301, a look-up table 302, and a device interface 303. The trackpad 301 generates a position corresponding to a trackpad location on the trackpad 301 being contacted and depressed by a user. The trackpad location contains a trackpad x-coordinate 311x and a trackpad y-coordinate 311y that are passed to the look-up table 302. The look-up table 302 translates the trackpad location into a joystick location within the joystick coordinate system 200. The joystick location contains a joystick x-coordinate 312x and a joystick y-coordinate 311y that are passed to the device interface 303. The device interface 303 outputs the joystick coordinate to a computing device in a specified signal format.

More specifically, the trackpad 301 is an ordinary trackpad device that has been mapped onto the inner surface of a concave-type bowl. The trackpad 301 is designed to output a digital value corresponding to the location within its surface depressed by a user. In the example embodiment, the trackpad outputs the trackpad x-coordinate 311x and a trackpad y-coordinate 311y in two 6-bit digital values. These coordinates are sent to the look-up table 302.

The look-up table 302 consists of a block of computer readable memory that uses a trackpad x-coordinate 311x and a trackpad y-coordinate 311y as address inputs to a particular memory location within the look-up table 302. The joystick x-coordinate 312x and joystick y-coordinate 312y data values are stored within this particular memory location that corresponds to the trackpad x-coordinate 311x and the trackpad y-coordinate 311y received from the trackpad 301. This look-up table 302 performs a simple and quick translation of the trackpad x-coordinate 311x and the trackpad y-coordinate 311y to the joystick x-coordinate 312x and the joystick y-coordinate 312y.

Other data values also may be used within the look-up table 302 to provide other coordinate transformations as desired by a user. For example, a particular coordinate system that provides more resolution of values about the center point 205 as defined above in FIG. 2. Typically, a joystick position at the center point 205 corresponds to a neutral position for a user of a pointing device to a game or similar application. Such an alternate coordinate system may provide finer control over positions about the center point 205 to allow a user to provide more sensitive control for the input values about the neutral point and then allow less sensitive controls toward the outer edge of the arcs of travel which may correspond to an extreme value for the input values. Other transformations also may be generated and stored within the look-up table 302.

The look-up table 302 also may contain multiple coordinate transformation tables to allow a user to quickly switch from one coordinate transformation to another transformation. For example, if two additional bits are appended to two upper address bits to the look-up table 302, and the 12-bit address defined by the trackpad x-coordinate 311x and a trackpad y-coordinate 311y is used for the lower bits to the address into the look-up table 302, four separate transformation tables may be stored within the look-up table 302. In such an embodiment, a user input such as a multi-position switch (not shown) may be used to define these two additional address bits with data values of 00, 01, 10, and 11. Each one of these values would consist of a separate coordinate transformation table as described above.

In addition, the look-up table 302 may be constructed using memory devices including random access memory (RAM), read-only memory (ROM), programmable read-only memory (PROM) or combination of the types of memory. RAM is memory that may be easily changed and typically maintains any data values stored therein only while the devices are operating. ROM is memory that permanently maintains the data values stored within regardless of the operating state of the device or whether electrical power is provided to the device. ROM is memory that provides long-term storage of the data values. PROM is memory that typically provides permanent storage of the data values stored within, however PROM memory may also be made to erase and re-write the data values stored therein. The PROM memory provides more permanent storage that may be changed infrequently as needed.

The use of these different types of memory may permit an attached computing device to utilize a default coordinate transformation from the trackpad x-coordinate 311x and the trackpad y-coordinate 311y to the joystick x-coordinate 312x and the joystick y-coordinate 312y using data values stored within ROM memory, while allowing computer downloaded coordinate transformation data to be added to the joystick by trackpad 100 when needed. The computer downloaded coordinate transformation data is provided from the attached computing device via the device interface 303, if supported.

The device interface 303 provides the electrical connection to allow the joystick by trackpad 100 to provide coordinate data values to applications and games within the computing device using the specified type of data signals.

In an embodiment in which analog joystick signals are used, the digital device interface 303 converts the joystick x-coordinate 312x and the joystick y-coordinate 312y to the pair of voltage levels that are expected as input signals by the computing device. A digital-to-analog converter and voltage amplifying and scaling circuitry may be used to perform this signal transformation. In other embodiments, the digital device interface corresponds to a digital data communications interface.

In other embodiments in which digital data signals are used to communicate between the joystick by trackpad 100 and the attached computing device, the device interface 303 provides the communications signals and signal timing needed to pass the data to and from the computing device. The digital device interface corresponds to a digital data communications interface. For example, these interfaces may use a serial data communication over a single data channel, including wired and wireless communications protocols. Wired communications channels may include USB, Firewire™, Lightning™, and Thunderbolt™ data connections. Other network protocols may also be used. Wireless communication may include, IR and RF direct serial connections, a Bluetooth™ connection, and a network-type connection such as WiFi. In a preferred embodiment, a simple and direct connection of either wired or wireless data is used as the joystick by trackpad device 100 is typically used in close proximity to the computing and gaming devices.

Even though particular combinations of features are recited in the present application, these combinations are not intended to limit the disclosure of the invention. In fact, many of these features may be combined in ways not specifically recited in this application. In other words, any of the features mentioned in this application may be included to this new invention in any combination or combinations to allow the functionality required for the desired operations.

No element, act, or instruction used in the present application should be construed as critical or essential to the invention unless explicitly described as such. Further, the phrase “based on” is intended to mean “based, at least in part, on” unless explicitly stated otherwise.

What is claimed is:

1. An article of manufacture for providing an analog joystick utilizing a trackpad, the analog joystick utilizing a trackpad communicatively coupled to a computing device to provide a coordinate position representing a position of a simulated analog joystick, the article comprises:
a concave and circular touch sensitive surface, the touch sensitive surface generates a 2-dimensional coordinate correspond to a point of contact by a user at on the touch sensitive surface;
a coordinate transformer for converting the 2-dimensional coordinate into a joystick coordinate; and
a digital device interface for communicating input position data containing the joystick coordinate to the computing device.

2. The article of manufacture according to claim 1, wherein the touch sensitive surface generates an x-axis value between 0 and 1023 and a y-axis value between 0 and 1023.

3. The article of manufacture according to claim 2, wherein a center location of the touch sensitive surface having a lowest point in the concave surface generates the x-axis value equal 512 and the y-axis value equal to 512.

4. The article of manufacture according to claim 1, wherein the coordinate transformer comprises a look-up table having and address input and a stored data value, the address input to the look-up table corresponds to the x-axis value and the y-axis value concatenated together, and the stored data value at each location within the loop-up table corresponds to a 2-dimensional position within the joystick coordinates.

5. The article of manufacture according to claim 4, wherein the joystick coordinates corresponds to a circle limited coordinates.

6. The article of manufacture according to claim 1, wherein the digital device interface corresponds to two analog voltages.

7. The article of manufacture according to claim 1, wherein the digital device interface corresponds to a digital data communications interface.

8. The article of manufacture according to claim 7, wherein the digital data communications interface corresponds to a wireless interface.

9. The article of manufacture according to claim 7, wherein the digital data communications interface corresponds to a USB interface.

10. A joystick input controller to a digital video gaming device, the joystick input controller comprises:
a concave and circular touch sensitive surface, the touch sensitive surface generates a 2-dimensional coordinate correspond to a point of contact by a user at on the touch sensitive surface, the touch sensitive surface generates an x-axis value between 0 and 1023 and a y-axis value between 0 and 1023, and a center location of the touch sensitive surface having a lowest point in the concave surface generates the x-axis value equal 512 and the y-axis value equal to 512;
a coordinate transformer for converting the 2-dimensional coordinate into a joystick coordinate, the coordinate transformer comprises a look-up table having and address input and a stored data value, the address input to the look-up table corresponds to the x-axis value and the y-axis value concatenated together, and the stored data value at each location within the loop-up table corresponds to a 2-dimensional position within the joystick coordinates; and
a digital device interface for communicating input position data containing the joystick coordinate to the computing device, the digital device interface corresponds to a digital data communications interface;
wherein the joystick coordinates corresponds to a circle limited coordinates.
